(19) United States
(12) Patent Application Publication
(10) Pub. No.: US 2011/0292146 A1
(43) Pub. Date: Dec. 1, 2011

(54) USE OF A GOLF BALL ORIENTATION DEVICE TO ORIENT A GOLF BALL FOR A CONTINUOUS FLOW, SINGLE PASS INKJET PRINTER

(75) Inventor: KEVIN SIGISMONDO, LUDLOW, MA (US)

(73) Assignee: CALLAWAY GOLF COMPANY, CARLSBAD, CA (US)

(21) Appl. No.: 12/953,045

(22) Filed: Nov. 23, 2010

Related U.S. Application Data
(60) Provisional application No. 61/285,443, filed on Dec. 10, 2009.
(60) Provisional application No. 61/285,488, filed on Dec. 10, 2009.

(51) Int. Cl. B41J 2/01

(52) U.S. Cl. 347/104

(57) ABSTRACT

A system for printing indicia on one or more golf balls using an inline inkjet printer is disclosed herein. The system of the invention comprises a golf ball orientation device and a continuous flow, single pass, inkjet printer. The golf ball orientation device of the system may comprise: at least one rotation device and at least one detent; a cup and a suction region; or a cup, at least one index arm, at least one vacuum line, at least one suction cup, and at least one pulse blower.

### CROSS REFERENCES TO RELATED APPLICATIONS

The present application claims priority to U.S. Provisional Application Nos. 61/285,443 and 61/285,488, both filed on Dec. 10, 2009, each of which is hereby incorporated by reference in its entirety herein.

### STATEMENT REGARDING FEDERALLY SPONSORED RESEARCH OR DEVELOPMENT

Not Applicable

### BACKGROUND OF THE INVENTION

1. Field of the Invention

The present invention relates to a golf ball orientation device. More specifically, the present invention relates to a golf ball orientation device to be used in connection with an inkjet printing process.

2. Description of the Related Art

Golf ball manufacturers generally use pad printers to perform production style printing on golf balls. Pad printers are not ideal for golf ball printing, however, because they are labor intensive, involve non-continuous flow printing, and require expensive operational supplies, including equipment and TPU ink that must be mixed by hand.

Inkjet printers, in contrast, are less expensive and less labor-intensive, but are difficult to use in connection with printing on golf balls. Manufacturers have had little success using current inkjet printing devices to achieve the quality, durability, and production speeds required for OEM printing on golf balls. One problem lies in the fact that the prior art does not disclose devices that orient golf balls, either internally or externally, for printing with inkjet printer systems. Other challenges that have not been resolved by the prior art include: (1) linking an orientation device to a printer; (2) providing an effective conveyor; (3) ensuring adequate printing speed; (4) feeding the orientation device with a desired quantity of golf balls.

There are several types of inkjet printers. Multi-pass or batch style inkjet printers require a printer head (or heads) to move proximate a ball, or the ball to move proximate the printer head, multiple times in a batch style fixture to apply an image. This is slower than a system that has a fixed, single pass printer head (or heads) with one or more balls on an inline or continuous flow style conveyor which passes the printer head once. The prior art fails to disclose an inline or continuous flow style conveyor inkjet system that can be used to effectively and economically print on golf balls.

In view of the above, there is a need to overcome present difficulties involved in using an inline inkjet printer to print high quality and durable images on golf balls.

### BRIEF SUMMARY OF THE INVENTION

The present invention is directed to a novel golf ball orientation device for use with a continuous flow, single pass inkjet printer. This orientation device allows images or indicia to be printed on ideal locations of a golf ball by the inkjet printer.

One aspect of the present invention is a system comprising a golf ball orientation device and a continuous flow, single pass, ink jet printer. The golf ball orientation device may comprise at least one rotation device and at least one detent, and may further comprise two detents for clamping a golf ball. The rotation device of the golf ball orientation device may be mechanically driven, such as by at least one turn bar, or it may be electrically driven, such as by a servo-driven motor. The rotation device may be attached to the detent of the golf ball orientation device.

In an alternative embodiment, the golf ball orientation device of the system may comprise a cup and a suction region, which may prevent a golf ball from rotating within the cup. In yet another embodiment, the golf ball orientation device may comprise a cup, at least one index arm, at least one vacuum line, at least one suction cup, and at least one pulse blower. In this embodiment, the vacuum line and pulse blower may align an unmilled golf ball within the cup. In any of the above embodiments, the golf ball orientation device may be fixed to a conveyor.

Another aspect of the present invention is a system comprising a conveyor, at least one pre-treatment device, a continuous flow, single pass, ink jet printer, at least one post-treatment device, and a golf ball orientation device, which may be fixed to the conveyor. The pre-treatment device of the system may be selected from the group consisting of an ultraviolet device, an LED device, a corona device, a plasma device, an infrared device, and an ionizing device. The post-treatment device of the system may be selected from the group consisting of an ultraviolet device, an LED device, a corona device, a plasma device, an infrared device, and an ionizing device. The golf ball orientation device may comprise at least one rotation device and at least one detent. In an alternative embodiment, the golf ball orientation device may comprise a cup and a suction region. In yet another alternative embodiment, the golf ball orientation device may comprise a cup, at least one index arm, at least one vacuum line, at least one suction cup, and at least one pulse blower.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a schematic view of a device for printing images on a golf ball.

FIG. 2 is an isolated view of a golf ball undergoing pre-treatment.

FIG. 3 is an isolated view of a golf ball undergoing pre-treatment.

FIG. 4 is an isolated view of a golf ball undergoing pre-treatment.

FIG. 5 is an isolated view of a golf ball undergoing pre-treatment.

FIG. 6 is an isolated view of a section of the device of FIG. 1.

FIG. 7 is an isolated view of a section of the device of FIG. 1.

FIG. 8 is an isolated view of a section of the device of FIG. 1.

FIG. 9 is a schematic view of golf balls conveyed under print heads.

FIG. 10 is a schematic view of golf balls conveyed under print heads.

FIG. 11 is an isolated view of a golf ball undergoing post treatment.

FIG. 12 is an isolated view of an embodiment of an orientation device.

FIG. 13 is an isolated view of a golf ball rotating in an orientation device.

FIG. 14 is an isolated view of an embodiment of an orientation device.

FIG. 15 is an isolated view of a rotation device.

FIG. 16 is an isolated view of a rotation device.

FIG. 17 is an isolated view of a golf ball in an orientation device.

FIG. 18 is a schematic view of an orientation device.

FIG. 19 is a schematic side view of an embodiment of a feed system.

FIG. 20 is a schematic side view of an embodiment of a feed system.

FIG. 21 is a schematic top view of an unloading system.

FIG. 22 is a schematic side view of an unloading system.

FIG. 23A is a schematic side view of an unloading system.

FIG. 23B is a schematic top view of the unloading system shown in FIG. 23A.

FIG. 24A is a schematic side view of a gate from the unloading system shown in FIG. 23A.

FIG. 24B is a schematic side view of a gate from the unloading system shown in FIG. 24A.

### DETAILED DESCRIPTION OF THE INVENTION

According to the present invention, use of a golf ball orientation device with an inkjet printer permits true automation for both custom imaging and full OEM production imaging on golf balls. The orientation device of the present invention allows for automatic orientation of golf balls placed on a continuous flow, single pass printer, thus improving the speed of orienting and loading golf balls on a continuous flow printer. Such automation ultimately increases printing capacity and decreases overhead costs associated with manual loading and orientation of golf balls in a printing system.

The golf ball orientation device of the present invention preferably is utilized with a continuous flow, single pass inkjet printer such as the printing system sold by Innovative Digital Systems, LLC of Indian Trail, N.C., under the model number SP2-100. Continuous flow, single pass, inline inkjet printers are superior to printers that are currently used to print images on golf balls. In contrast with current golf ball printer systems and printing techniques, inline inkjet printers do not require the same expensive operating supplies, do not stop to print an image, and are less labor intensive to operate.

One benefit of continuous flow inkjet printer systems is the fact that they permit the addition of fixed auxiliary equipment inline for pre- or post-printing treatment, including plasma, corona, UV lights, LED lights, and other treatment devices. Other equipment that can be added to continuous flow inkjet printer systems includes multiple print heads and multiple printing rows placed inline to print on multiple balls in a single pass. Yet another advantage of using an inline inkjet printer to print on golf balls is the decreased complexity in designing auxiliary equipment to load, convey, and unload balls. These options improve print quality, durability, and production speeds

The feed to the printing system of the present invention can be manual or automated, and balls may be aligned or not aligned. The exit of this printing system may be manual or automated, and the balls may exit being aligned or not aligned.

The orientation device and printing system of the present invention may be used to print on any type of golf ball, including two-piece and multiple-layer golf balls.

The use of a continuous flow, single pass inkjet printer to apply an image to one or more golf balls for production constitutes a new golf ball finishing process. Also new to the golf ball printing process is the use of pre- and post-printing treatments, including but not limited to UV, LED, corona, plasma, ionized air, infrared, and other devices or treatments, to improve image adhesion, quality, and durability. Additionally, the use of inkjet printer head imaging with 300 dots per inch (dpi) resolution or higher and production speeds equal to or greater than 12 images per minute is new to golf ball production. Finally, the use of a conveyor system for continuous flow of golf balls to the printer head and to auxiliary equipment for pre- and post-printing treatment processes is an improvement over prior art production techniques.

### Continuous Flow Inkjet Printing System

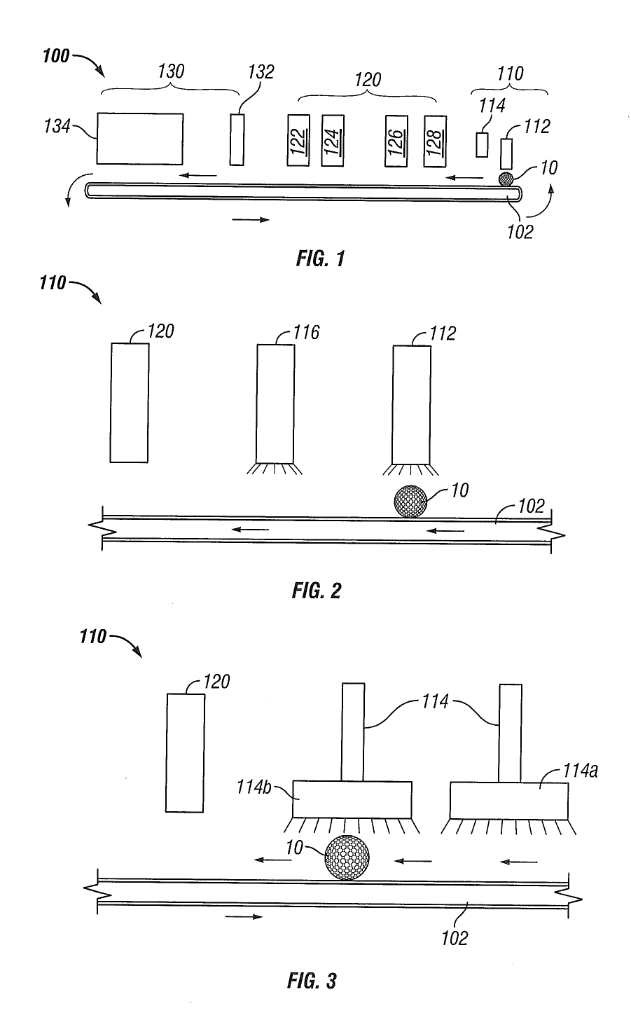

A preferred continuous flow, single pass inkjet printing system 100 is shown in FIG. 1. A single golf ball (or, alternatively, multiple rows of golf balls) 10 is aligned and placed on or fixed to a transportation fixture or conveyor 102 that passes the golf ball by various auxiliary devices and printer heads.

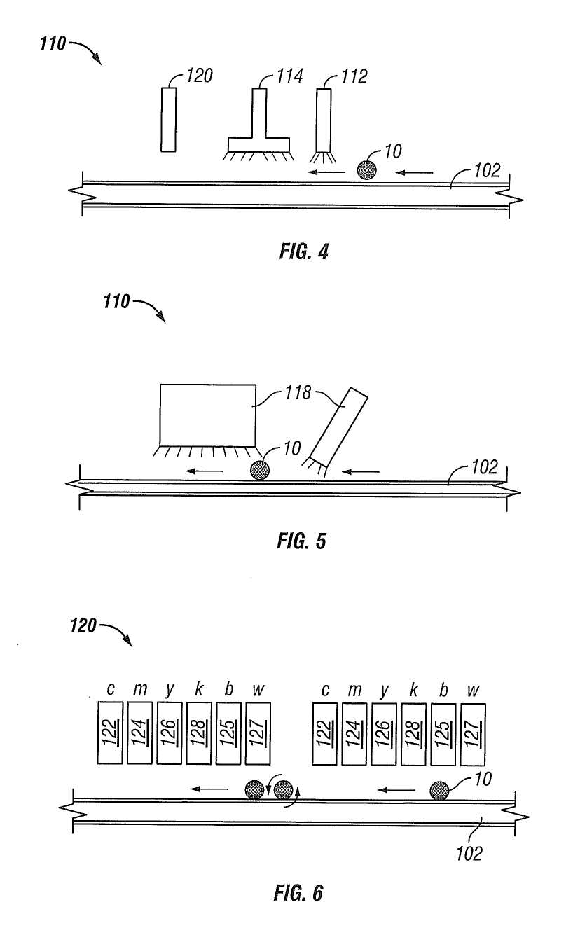

As shown in FIG. 1, a first stage of the printing system is pretreatment 110, which may include a plasma and/or corona treatment 112 and LED treatment 114. Pre-treatment of multiple sides of a golf ball 10 can improve surface adhesion of the ink to the golf ball 10 by increasing the surface energy of the golf ball 10. FIG. 2 shows a golf ball 10 undergoing a single corona or plasma pre-treatment 112. As shown in FIG. 2, the golf ball 10 may then undergo another pretreatment 116 before being conveyed to inkjet printer heads 120. FIG. 3 shows a golf ball receiving LED pre-treatment 114. The golf ball may receive one LED pretreatment 114a or more than one LED pretreatment 114b before being conveyed to inkjet printer heads 120. FIG. 4 shows a golf ball 10 receiving a combination corona and/or plasma pre-treatment 112 and LED pre-treatment 114 before being conveyed to printer heads 120. FIG. 5 shows a golf ball receiving an alternative type of pre-treatment 110 via ionizers 118.

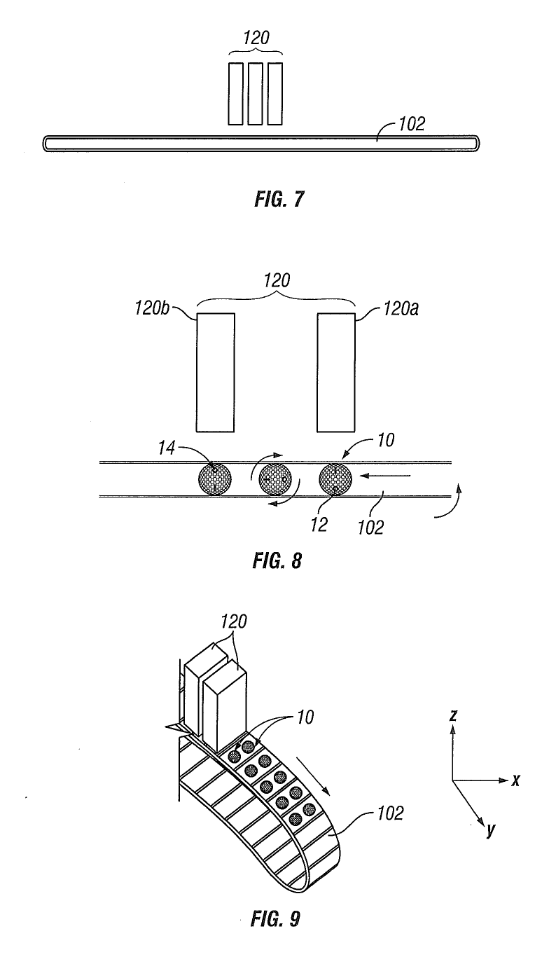

Once pre-treatment 110 is complete, the one or more golf balls 10 conveyed through the printing system 100 will pass one or more single-pass inkjet print heads 120 as shown in FIG. 1. In a preferred embodiment, shown in FIG. 6, there are at least four inkjet print heads 120 having colors including cyan 122, magenta 124, yellow 126, and key black 128, known as “CMYK,” which can add a preprogrammed image to the golf ball 10. As shown in FIG. 6, there may also be print heads 120 for black 125 and white 127. In an alternative embodiment, shown in FIGS. 7 and 8, the printer heads 120 can have fewer print heads 120 providing colors other than CMYK, including, for example, custom ink colors chosen by the manufacturer.

During printing, the one or more golf balls 10 are rotated again and again and are passed under one or more single-pass inkjet print heads to receive images on different sides, or “poles.” FIGS. 6 and 8 show golf balls 10 rotating as they pass from one set of printer heads, or one printer head, to another. This step may be done multiple times inline without interrupting the continuous feed to the printer. Rotating the golf balls 10 allows poles of each ball to be printed upon by the inline inkjet printer. For example, in FIG. 8, a first pole 12 of the golf ball 10 is printed upon by a first printer head 120a. The golf ball 10 is then rotated so a second pole 14 of the golf ball 10 can be printed upon by a second printer head 120b. Additional printer heads 120 can be added to this system if additional poles require print images.

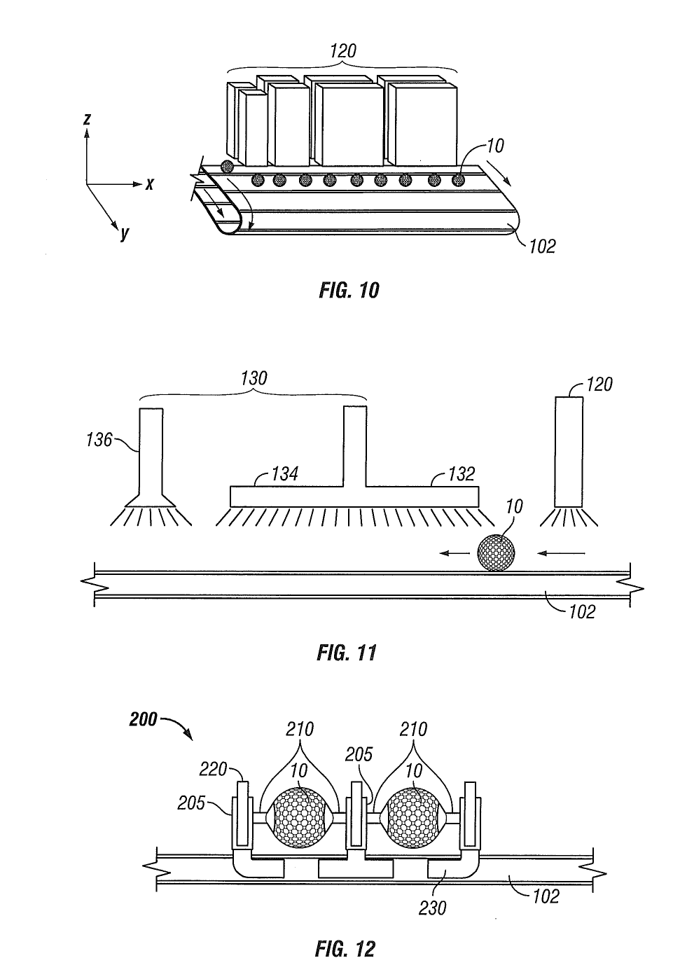

The continuous flow, single pass inkjet printing system 100 of the present invention may be designed to print on one golf ball 10 at a time, as shown in FIGS. 1-8. In a preferred embodiment, however, the printing system 100 of the present invention can print on more than one golf ball 10 at a time. FIGS. 9 and 10 illustrate how to configure the printing system 100 to increase printing capacity. As shown in FIG. 9, the conveyor 102 and the printer heads 120 are widened along an x axis to accommodate more than one ball, thus increasing throughput. The system shown in FIG. 9 also includes additional printer heads 120 arranged along the y axis. FIG. 10 shows that adding more printer heads 120 in a line along x and y axes, and increasing the width of the conveyor 102 along the x axis, allows for more print colors and/or print locations for the golf balls. The arrangements disclosed in FIGS. 9 and 10 can be used at high or low conveyor speeds, and with high or low dpi (resolution).

After printing is complete, the golf ball 10 moves past the printer head 120 region of the printing system 100 and is exposed to post-treatment steps 130. Post-treatment may include exposure to LED 132 or ultraviolet 134 curing lights, as shown in FIGS. 1 and 11. Pre-treatment devices disclosed herein, such as an ionizer 136, may also be used as a post-treatment device. The golf ball may be rotated during the post-treatment process so that multiple sides of the ball 10 are permitted to cure.

### Orientation Devices and Methods

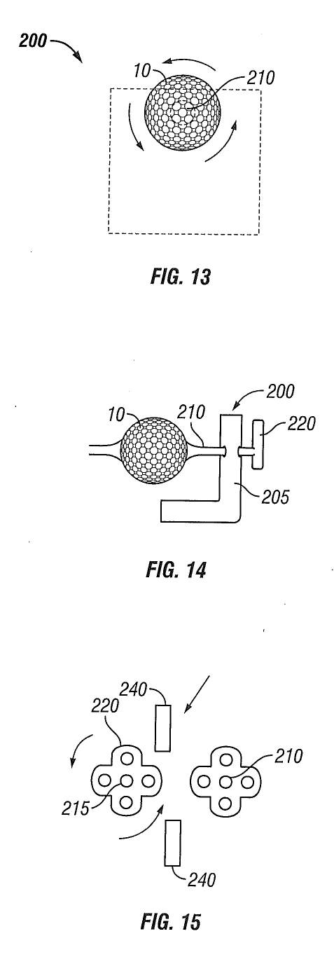

A preferred embodiment of the orientation device 200 of the present invention is shown in FIG. 12. This orientation device 200 is a clamp fixture with detents 210, 215 for grasping a golf ball 10, at least one rotation device or cam 220 integrated into at least one side 205 of the clamp fixture to rotate the detents 210, 215, and thus cause the golf ball 10 to rotate in place once it is clamped to the orientation device 200 between detents 210, 215, and a sole portion 230 that attaches to the conveyor 102 of the inline printing system 100. This embodiment is an example of an internal orientation device 200 because the device 200 rotates a golf ball 10 within the structure of the device 200, and the device 200 is not considered a part of the inkjet printer system 100. FIG. 13 shows a golf ball 10 clamped in the orientation device 200 and rotating within it. In another embodiment of the orientation device, shown in FIG. 14, the cam 220 is not integrated into a side 205 of the orientation device 200, but instead is a separate piece that is affixed or proximate to the orientation device 200.

In one embodiment, shown in FIG. 15, the cam 220 has a locking mechanism that allows the cam 220 to turn in 90 degree increments while the detents 210, 215 hold a golf ball 10 within the orientation device. FIG. 15 is a sectional view of two cams 220 rotating between four distinct locations or poles. This arrangement allows four poles of the golf ball 10 to be exposed to printer heads 120. The cam 220 in this embodiment is attached to the detents 210, 215 and causes them to rotate, thus rotating a clamped golf ball 10. One or more turn bars 240 force the cam 220 to rotate between each pole. In such an embodiment, the cam 220 is mechanically driven by the one or more turn bars 240.

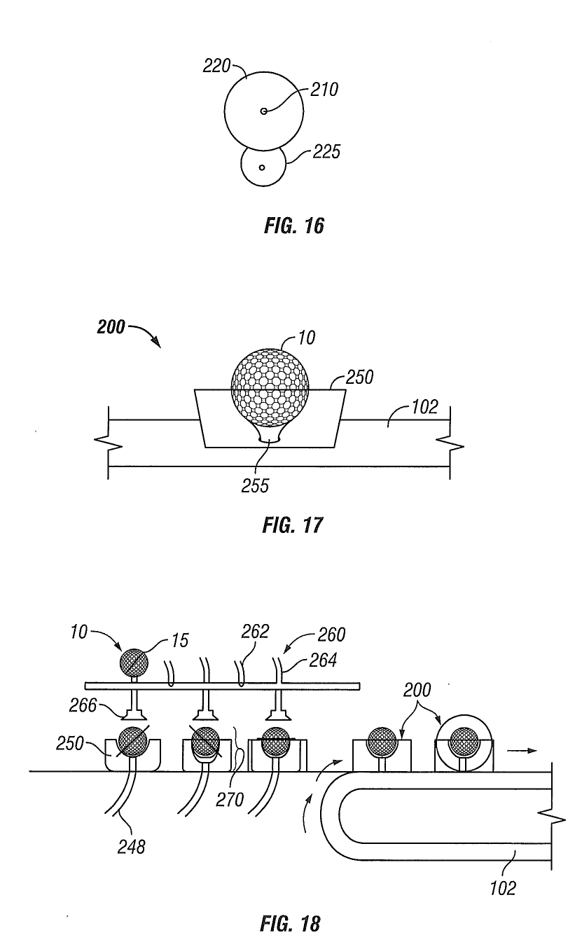

In yet another embodiment of the orientation device 200, the detents 210, 215 are attached to a rotation device or cam 220 having more than four distinct stopping points. In this embodiment, shown in FIG. 16, the cam 220 is circular and is forced to turn by a servo-driven motor 225. The servo-driven motor 225 may be electrical and allows the cam 220 to stop at any position along the 360 degree rotation, not just at 90 degree increments. The servo-driven motor 225 embodiment of the orientation device 200 allows a manufacturer to fine-tune the locations on a golf ball 10 on which an image will be printed.

In another embodiment of the orientation device 200 of the present invention, shown in FIG. 17, a golf ball 10 is placed into a cup 250 that is permanently or removably affixed to the conveyor 102. Inside the cup 250 is a suction region 255 through which a vacuum or suction is applied to the golf ball 10 to hold the golf ball 10 in place within the cup 250. The suction region 255 may be a nozzle, pedestal, or other locating device that orients the golf ball 10 within the cup 250. This embodiment limits printing to one side of the golf ball 10, as the suction region 255 prevents the ball from rotating within the cup 250. In other words, the suction region 255 retains the golf ball 10 in a single position.

Yet another embodiment of the orientation device 200 of the present invention is particularly useful for golf balls having seams, equator gates, flash, or residue on their sides from molding. If a non-milled golf ball 10 is not oriented properly within an inkjet printing system 100, an image may be printed upon the seam or residue, which will later be milled from the golf ball, thus wasting ink and mining the printed image.

The embodiment shown in FIG. 18 solves this problem by orienting the golf ball 10 using the seam 15 or residue as a guide and positioning the golf ball so that a comparatively smooth surface is exposed for printing. The orientation system 260 shown in FIG. 18 includes one or more index arms 262, vacuum lines 264, suction cups 266, and pulse blowers 268. This embodiment is an example of an external orientation device 200 because the device 200 can be integrated into the inkjet printer system 100 itself. As shown in FIG. 18, index arms 262 guide an unmilled golf ball 10 into a cup 250, where a vacuum line 264 and pulse blower 268 pull and push against the golf ball 10, respectively, until it is aligned within the cup 250 with its seam 15 resting against the edges of the cup 250, as shown by 270. Once the unmilled golf ball 10 is so aligned, the cup 250 may be conveyed through an inline inkjet printer system. Alternatively, a suction cup 266 may lift the golf ball in its aligned position from the cup 250 and place it in another orientation device 200, such as those described above and in FIGS. 12-17. The unmilled golf ball 10 may then be conveyed through an inline inkjet printer system.

The orientation device 200 shown in FIG. 18 may also have a mill removal function, whereby the equator flash or seam 15 on the golf ball 10 may be milled away once the golf ball 10 is aligned within the cup 250. The mill removal may be effectuated by blades or sanding devices proximate or integral to the cup 250. This option is feasible because the golf ball 10 retains its alignment once the orientation device 200 has oriented the golf ball 10 for printing.

### Golf Ball Feeding and Unloading Systems

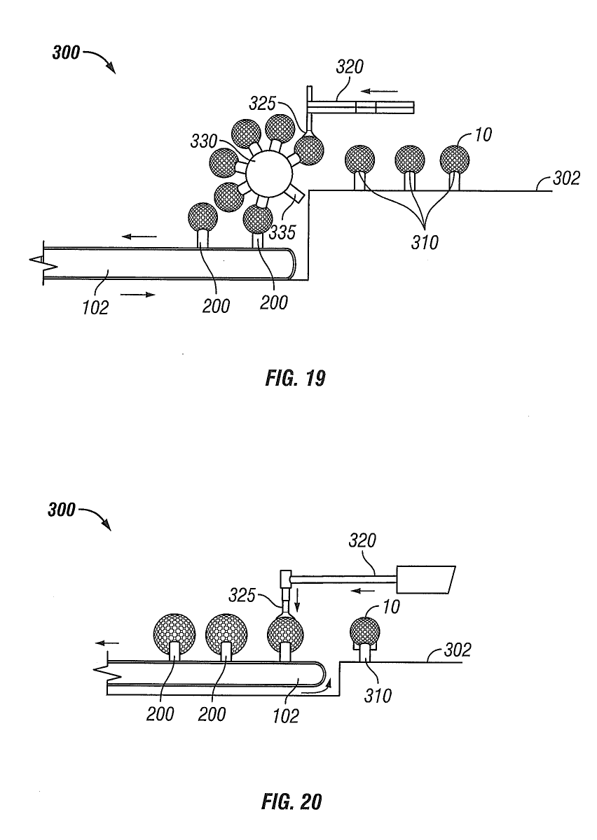

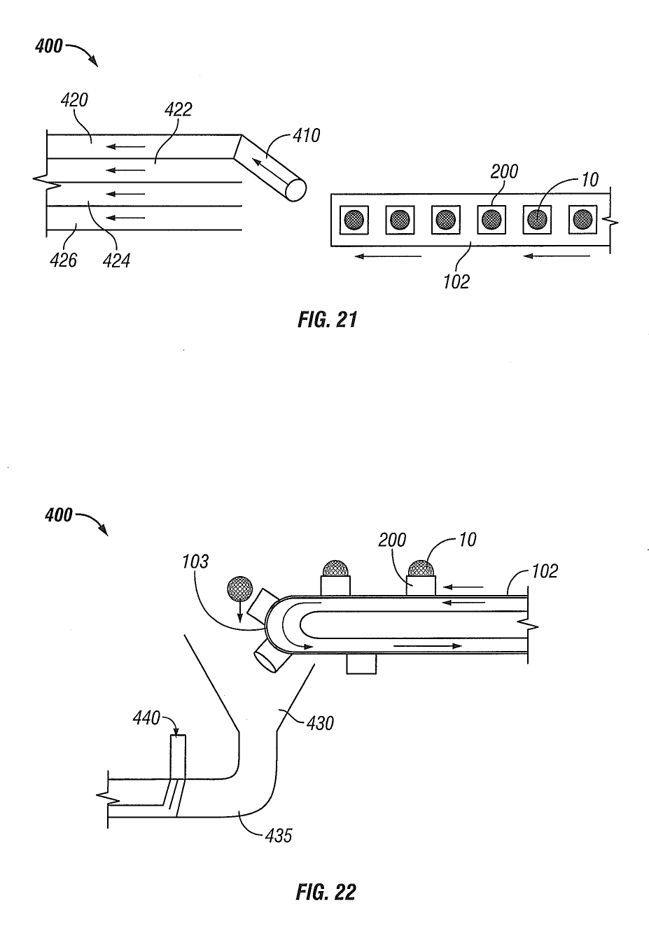

The orientation device(s) and inline inkjet printing systems of the present invention may be used in connection with golf ball feeding and unloading systems to increase throughput of golf balls and reduce the labor involved in loading (and unloading) golf balls into a printing system. FIGS. 19 and 20 show two embodiments of golf ball feed systems 300 that may be used with the inkjet printing system of the present invention, and FIGS. 21-24B show three embodiments of golf ball unloading systems 400.

The feed system 300 disclosed in FIG. 19 includes a loading conveyor 302 with platforms 310 that convey golf balls 10 from a source (not shown). The orientation and condition of the golf balls 10 may be visually inspected as they are transported along the conveyor 302. An air piston 320 with a suction cup 325 lifts golf balls 10 from platforms 310 and moves them onto a load wheel 330. Alternatively, the load wheel 330 may move golf balls 10 from the conveyor 102 without assistance from an air piston 320. The load wheel 330 has multiple arms 335 for holding golf balls 10 and can hold multiple golf balls 10 simultaneously. The load wheel 330 rotates to deposit each golf ball 10 onto an orientation device 200, which may be one or more of the orientation devices 200 disclosed herein. The conveyor 102 then carries each golf ball 10, located in an orientation device 200, through an inline inkjet printing system 100.

A preferred embodiment of the feed system 300 is disclosed in FIG. 20. This feed system 300 does not require a load wheel 330, and includes a loading conveyor 302 with one or more platforms 310 that convey golf balls 10 from a source (not shown). The orientation and condition of the golf balls 10 may be visually inspected as they are transported along the conveyor 302. An air piston 320 with a suction cup 325 lifts golf balls 10 from the one or more platforms 310 and moves them to an orientation device 200, which may be one or more of the orientation devices 200 disclosed herein. The conveyor 102 then carries each golf ball 10, located in an orientation device 200, through an inline inkjet printing system 100.

One embodiment of a golf ball unloading system 400 is disclosed in FIG. 21. Golf balls 10 carried by conveyor 102 in orientation devices 200 from an inline inkjet printing system 100 are transferred to an actuator/diverter device 410, which diverts golf balls 10 to different channels or chutes 420, 422, 424, 426, thus allowing for efficient sorting of golf balls 10 by number (1, 2, 3, 4, etc.), size, color, logo, and/or another desired characteristic. The actuator/diverter device 410 may be mechanically or electrically driven, and the golf balls carried by conveyor 102 may be carried without orientation devices 200. This unloading system 400 may also be used to sort the golf balls 10 before they are printed upon, i.e., can be used as a feed system 300 to the inkjet printer system 100. It also may be used for quality inspection.

Another embodiment of a golf ball unloading system 400 is shown in FIG. 22. Golf balls 10 in orientation devices 200 are carried by conveyor 102. At the end 103 of the conveyor 102, the golf balls 10 fall from the conveyor into a chute 430 and are directed down a tube or channel 435. A pneumatic activator or ball diverter 440 located proximate or in the channel 435 then directs the golf balls 10 in desired directions. This unloading system 400 can direct balls to packagers, and may also be used as a feed system 300 or for quality inspection before printing.

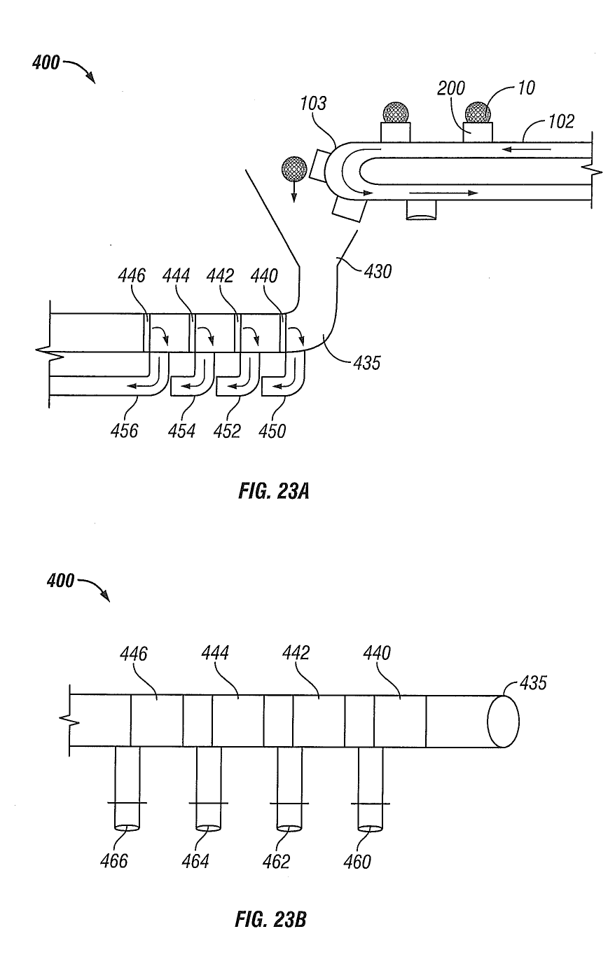

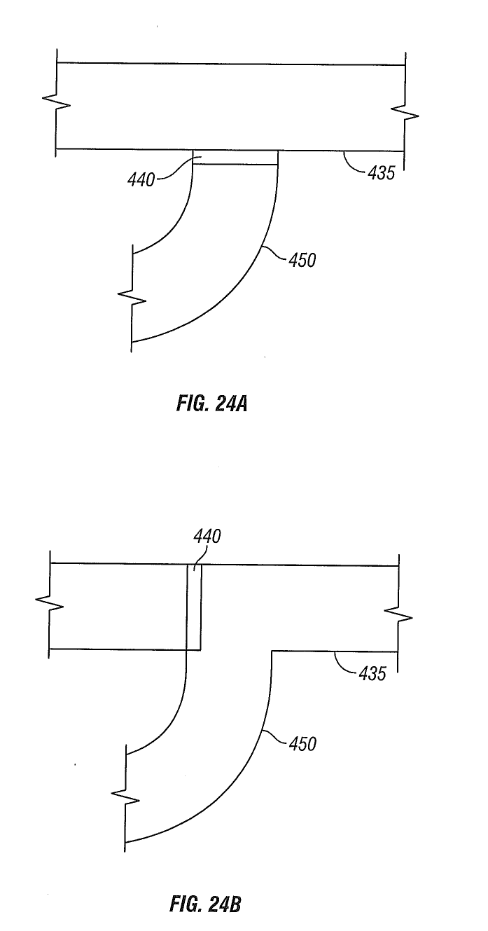

A preferred embodiment of the golf ball unloading system 400 is shown in FIGS. 23A and 23B. Golf balls 10 in orientation devices 200 are carried by conveyor 102. At the end 103 of the conveyor 102, the golf balls 10 fall from the conveyor into a chute 430 and are directed down a tube or channel 435. A series of gates 440, 442, 444, 446 open and close to direct golf balls 10 into diversion tubes 450, 452, 454, 456 according to desired characteristics including, but not limited to, number (1, 2, 3, 4, etc.), size, color, and/or logo. An open gate 440, shown in FIG. 24B, stops the ball 10 as it rolls down the channel 435 and allows the ball to drop into the diversion tube 450 associated with that gate 440. In contrast, a closed gate, shown in FIG. 24A, covers the diversion tube 450 associated with that gate 440 and allows a golf ball 10 to move past the diversion tube 450. As shown in FIG. 23B, pneumatic controls 460, 462, 464, 466 may control the gates 440, 442, 444, 446 and determine whether they are opened or closed.

The present invention, and the embodiments disclosed herein, improves the process of adding an image to a golf ball by reducing operating costs, improving productivity, reducing lead time, and increasing or maintaining current image quality.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention the following:

1. A system comprising:
a golf ball orientation device; and
a continuous flow, single pass, ink jet printer.

2. The system of claim 1, wherein the golf ball orientation device comprises at least one rotation device and at least one detent.

3. The system of claim 2, wherein the golf ball orientation device comprises two detents for clamping a golf ball.

4. The system of claim 2, wherein the rotation device is mechanically driven.

5. The system of claim 4, wherein the rotation device is a cam driven by at least one turn bar.

6. The system of claim 2, wherein the rotation device is electrically driven.

7. The system of claim 6, wherein the rotation device is powered by a servo-driven motor.

8. The system of claim 2, wherein the rotation device is attached to the detent.

9. The system of claim 1, wherein the golf ball orientation device comprises a cup and a suction region.

10. The system of claim 9, wherein the suction region prevents a golf ball from rotating within the cup.

11. The system of claim 1, wherein the golf ball orientation device comprises a cup, at least one index arm, at least one vacuum line, at least one suction cup, and at least one pulse blower.

12. The system of claim 11, wherein the vacuum line and pulse blower align an unmilled golf ball within the cup.

13. The system of claim 2, wherein the golf ball orientation device is fixed to a conveyor.

14. A system comprising;
a conveyor;
at least one pre-treatment device;
a continuous flow, single pass, ink jet printer;
at least one post-treatment device; and
a golf ball orientation device.

15. The system of claim 14, wherein the golf ball orientation device is fixed to the conveyor.

16. The system of claim 14, wherein the pre-treatment device is selected from the group consisting of an ultraviolet device, an LED device, a corona device, a plasma device, an infrared device, and an ionizing device.

17. The system of claim 14, wherein the post-treatment device is selected from the group consisting of an ultraviolet device, an LED device, a corona device, a plasma device, an infrared device, and an ionizing device.

18. The system of claim 14, wherein the golf ball orientation device comprises at least one rotation device and at least one detent.

19. The system of claim 14, wherein the golf ball orientation device comprises a cup and a suction region.

20. The system of claim 14, wherein the golf ball orientation device comprises a cup, at least one index arm, at least one vacuum line, at least one suction cup, and at least one pulse blower.
